(19) United States
(12) Patent Application Publication
(10) Pub. No.: US 2014/0210201 A1
(43) Pub. Date: Jul. 31, 2014

(54) VARIABLE PRINTING OF THERMOCHROMIC CODES

(71) Applicant: CHROMATIC TECHNOLOGIES INC., Colorado Springs, CO (US)

(72) Inventors: Timothy J. Owen, Colorado Springs, CO (US); Terrill Scott Clayton, Colorado Springs, CO (US)

(73) Assignee: CHROMATIC TECHNOLOGIES INC., Colorado Springs, CO (US)

(21) Appl. No.: 14/186,958

(22) Filed: Feb. 21, 2014

Related U.S. Application Data
(63) Continuation-in-part of application No. PCT/US2012/051941, filed on Aug. 22, 2012.
(60) Provisional application No. 61/889,447, filed on Oct. 10, 2013.
(60) Provisional application No. 61/526,211, filed on Aug. 22, 2011.

(51) Int. Cl. G09F 3/00

(52) U.S. Cl. CPC G09F 3/0291; G09F 2003/0211
USPC 283/94

(57) ABSTRACT

Promotional codes are printed using thermochromic inks in a manner that conceals the codes until a beverage or other article is cooled sufficiently to reveal the codes.

### CROSS-REFERENCE TO RELATED APPLICATIONS

This application claims the benefit of priority of U.S. Provisional Application No. 61/889,447 filed Oct. 10, 2013, and is a continuation-in-part of International Application No. PCT/US2012/051941 filed Aug. 22, 2012 which claims priority to U.S. Provisional Application No. 61/526,211 filed Aug. 22, 2011.

### BACKGROUND

Printed articles of manufacture may contain hidden codes or other indicia that may be used to redeem promotional materials or other valuable things. By way of example, a state lottery may be conducted using printed cards that utilize a plasticized ink to cover an area of the card stating a cash amount that may be revealed by scratching off the plasticized ink. A bottled soft drink may be sealed with a crown, the inside of which contains a promotional code that is redeemed by use of the Internet. A candy bar wrapper may also have an interior surface bearing this type of code, which is revealed only after the candy bar is unwrapped. Promotional indicia may be printed on bars of soap as taught in U.S. Pat. No. 7,743,704.

Thermochromic inks are not generally regarded as being useful in the variable printing of promotional or other codes. This is because thermochromic inks contain thermochromic pigments in the form of microcapsules that are typically melamine-formaldehyde microcapsules, for example, as taught by U.S. Pat. No. 5,591,255 issued to Small et al., which is hereby incorporated by reference to the same extent as though fully replicated herein. These microcapsules range in size with particle diameters from 0.5 to fifteen microns. These particle sizes may not work well with individually configurable printing systems, such as ink jet printing.

### SUMMARY

The present disclosure overcomes the problems outlined above and advances the art by providing methods and apparatus for variable printing of promotional or other codes using thermochromic inks.

In one embodiment, label is provided that supports variable printing of codes using thermochromic ink. A background may be printed using a background ink having a first color. A thermochromic ink is printed to overlay the background ink, and there is adopted a means for concealing a code that is revealed when the thermochromic ink undergoes a color transition. This means may be, for example according to one embodiment, a code printed over the background ink, the code being printed with an ink that matches the background ink. The thermochromic ink is colorless at room temperature and exhibits a color change upon sufficient cooling to reveal the code.

In one embodiment, the means for concealing may be a code printed in thermochromic ink over the background ink. The code is printed with an ink that is colorless at room temperature and exhibits a color change upon sufficient cooling to reveal the code.

In one embodiment according to these instrumentalities, a label is provided to supports use of variable printing of matrix codes using thermochromic ink. A first matrix code is printed using a first thermochromic ink that is colorless until cooled to a first predetermined temperature which renders the first matrix code visible in a first color. A second matrix code printed using a second thermochromic ink that provides a second matrix code when cooled to a second predetermined temperature which renders the second matrix code visible in a second color. The first thermochromic ink and the second thermochromic ink are clear at normal room temperature.

### BRIEF DESCRIPTION OF THE DRAWINGS

FIG. 1 shows a system for variable printing of thermochromic codes according to one embodiment;

FIG. 2 shows a label that has been partially printed using the system of FIG. 1;

FIG. 3 shows a label that has been completely printed using the system of FIG. 1;

FIG. 4 shows the label of FIG. 3 adhered to a beverage bottle;

FIG. 5 shows a label in successive stages of printing according to a laser ablation embodiment;

FIG. 6 shows a label in successive stages of printing according to an ink overlay embodiment;

FIG. 7 shows a label in successive stages of printing according to an ink overlay embodiment, where FIG. 7A shows an expanded portion thereof;

FIGS. 8A and 8B show a label in successive stages of printing according to a two dimensional matrix overlay embodiment.

FIG. 9 is a plot showing a rate of color change versus temperature in a conventional thermochromic ink.

FIG. 10 is a plot showing a rate of color change versus temperature in a conventional thermochromic memory ink.

FIG. 11 shows a patch that may be printed on a beverage can, label or packaging to provide thermochromic functionality of indicia according to one embodiment.

FIG. 12 shows a patch that may be printed on a beverage can, label or packaging to provide reveal functionality of indicia according to one embodiment.

FIG. 13 shows a patch that may be printed on a beverage can, label or packaging to provide reveal functionality of indicia according to one embodiment.

FIG. 14 shows a patch that may be printed on a beverage can, label or packaging to provide reveal functionality of indicia according to one embodiment. FIG. 13 shows a patch that may be printed on a beverage can, label or packaging to provide reveal functionality of indicia according to one embodiment.

FIG. 15 shows a patch that may be printed on a beverage can, label or packaging to provide reveal functionality of indicia according to one embodiment.

FIG. 16 shows beverage cans as they may appear differently due to the functionalities of thermochromic and photochromic materials combined for printing on a single can.

FIG. 17 shows a beverage can as it may appear differently due to the functionalities of thermochromic and photochromic materials combined for printing on a single can.

FIG. 18 shows a beverage can as it may appear differently due to the functionalities of thermochromic and photochromic materials combined for printing on a single can.

FIG. 19 shows a bottle crown as it may appear differently due to the functionalities of thermochromic and photochromic materials combined for printing on a single crown.

FIG. 20 shows a level indicator printed as a pilsner glass that combines thermochromic and photochromic materials.

### DETAILED DESCRIPTION

System 100 contains a roll 102 of material that is continuously unrolled to form a web 104. The web 104 may be, for example, paper or plastic material adhered to a release layer from which may be produced selectively detachable adhesive labels, or a sheet of aluminum. Print stations 106, 108 apply ink to the passing web 104. Print station 110 is for rotogravure printing as is known in the art. A laser station 112 is positioned for operations on the printed web 104. An optional platen assembly 114, 116 is positioned for vertical strokes 118 to cut selected portions of the web 104 into detachable labels (not shown). The printed web 104 is rolled into a demountable spool 120 for later use. A programmable computer 122 governs operations of system 100.

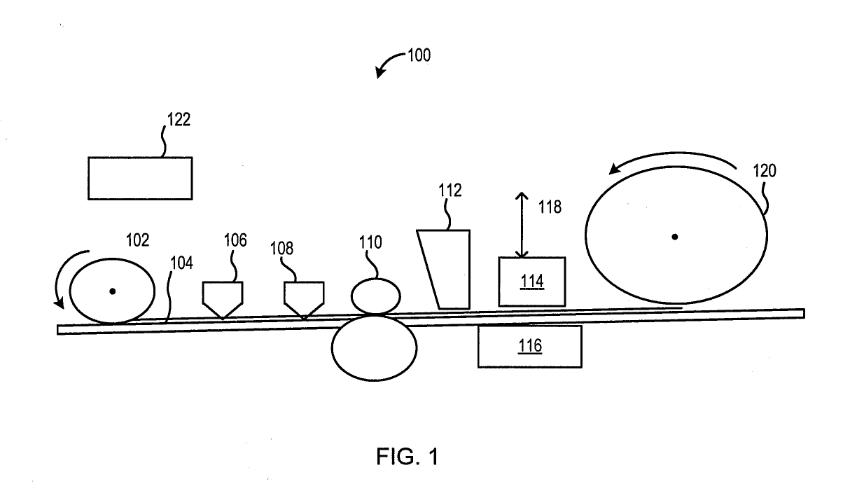

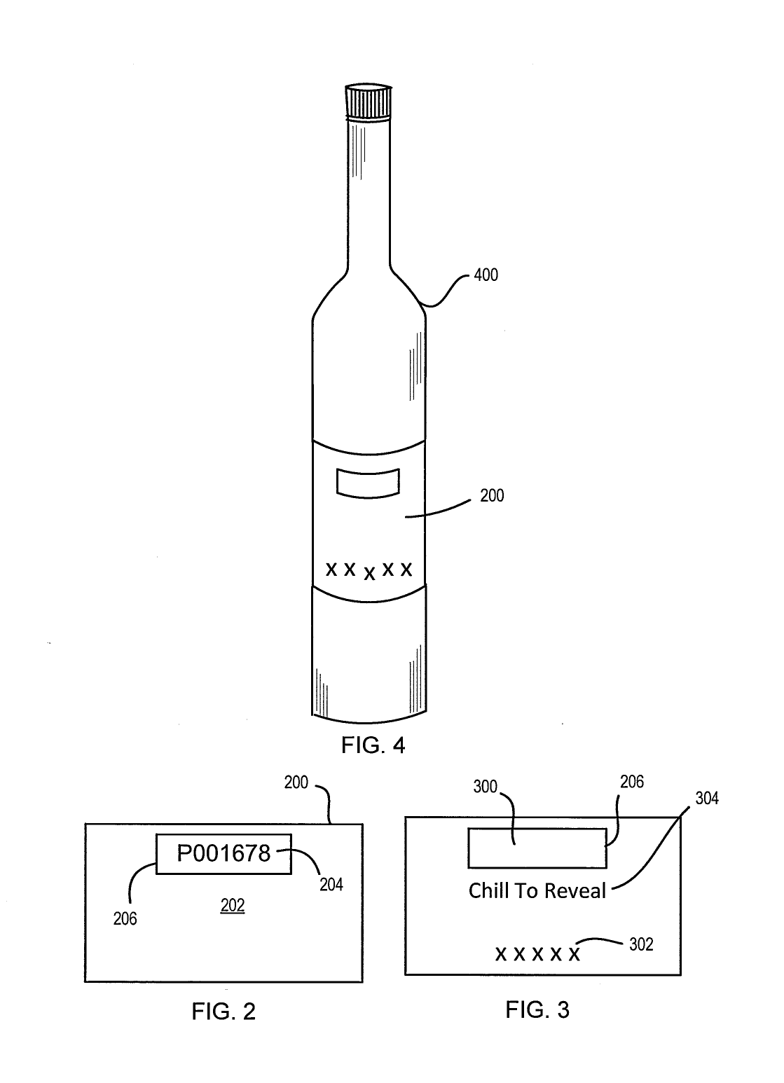

FIG. 2 shows a label 200 that contains surface 202 with indicia including a promotional code 204 in area 206. The promotional code 204 may be printed using thermochromic ink of any color, such as thermochromic ink that may be purchased on commercial order from Chromatic Technologies, Inc. of Colorado Springs, Colo. The area 206 may be left unprinted with ink or may be covered with ink that differs from the thermochromic ink of code 204. The promotional code 204 and any ink optionally placed in area 206 may be printed, for example, using print head 106 (see FIG. 1). As shown in FIG. 3, the area 206 and the code 204 (not shown) have been covered by ink 300, as applied by print station 108 (See FIG. 1). The print station 110 has applied additional ink to form indicia 302, 304. The indicia 304 optionally provides instructions for use of the promotional code 204 at print station 110, such as “Chill to Reveal.” FIG. 4 shows the label 200 applied to a bottle 400.

The sequence of printing on area 206, the promotional code 204 and the ink 300 may be provided in any combination. For example, in one embodiment, neither the ink on area 206 or the ink 300 are required. In one embodiment, indicia on the label 200 may consist only of the promotional code 204 and the top coat of ink 300.

The spool 120 shown in FIG. 1 may contain a plurality of such labels 200, each bearing a different promotional code 204 as directed by the programming of computer 122 (see FIG. 2). The labels may be detached from spool 120 and applied to the bottles by automated equipment as is well known in the art. The spool 120 is not essential and the web 104 run for direct use at any downstream process.

### Laser Ablation

The promotional code 204 may be formed using laser ablation. One solution is to perform laser ablation of the ink. By way of example, screen printing may be used to cover entirely the area 206 of FIG. 2 with a band of thermochromic ink that is colorless when warm and which exhibits a color change when chilled. This color change may be, for example, from clear to blue. The laser station 112 ablates unwanted portions of ink in area 206 to leave the promotional code 204 using the methodologies reported, for example, in United States Patent Publication No. US 2009/0128860 to Graushar et al., which is incorporated by reference to the same extent as though fully replicated herein. The laser wavelength, pulsing frequency and applied power may be tuned to accommodate a particular thermochromic inks. While some of the ‘clear’ thermochromic inks used in this application are undetectable, other inks may leave a residue that is slightly visible. In these circumstances the top coat 300 (see FIG. 3) may be used to hide this residue.

In one embodiment, the area 206 may be screen printed with a colored ink, such as a white ink, and topcoated with a thermochromic ink that is clear at normal room temperature. The thermochromic ink may be laser ablated to form code 204 while leaving intact the ink over area 206. The thermochromic ink forming code 204 changes color when chilled to a predetermined temperature to contrast with the in on area 206, for example, forming the code 204 in blue on the white background of area 206. Ink 300 may seal or protect the code 204 and cover any ascertainable differences, such as a change in glossiness that might otherwise reveal code 204 to the naked eye even before the label is cooled to the predetermined color transition temperature.

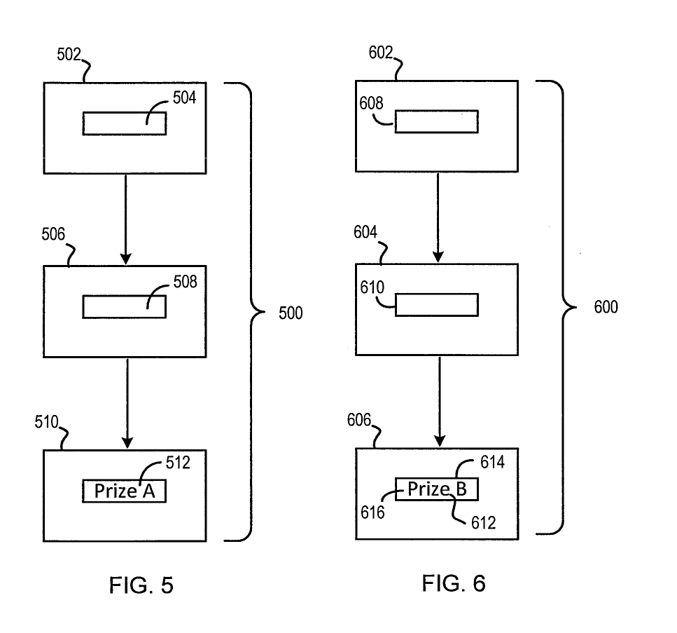

In another example, FIG. 5 shows a label 500 at different stages of printing, 502 (FIG. 5A), 506 (FIG. 5B) and 508 (FIG. 5C). A background area 504 is printed at stage 502. This background may be, for example, a white or gray background. A thermochromic band 508 may be printed at stage 506 and laser ablated at stage 510 to form promotional code 512.

Direct Print over Thermochromic Band with Matching Background

A thermochromic pigment is prepared as taught in U.S. Pat. No. 5,591,255, except the pigment is screened to eliminate larger particle sizes. By way of example, the pigment may be centrifuged to separate particles by density gradient, and/or passed through a polyester or nylon screen, such as those obtainable on commercial order from Miami Aqua-culture of Boynton-Beach Fla., or any other source of micron screens known to the art. The screening may eliminate particles of over a certain size, such as by eliminating particles over a size that would be problematic to ink jet printing. Generally, this should eliminate particles over about 5 microns in diameter. Preferably, the particles have a size less than 3 microns and this is most preferably less than 1 micron. The screened pigment may then be used as pigment in a conventional formulation for ink jet ink, for example, as taught in U.S. Pat. No. 5,207,824 issued to Moffatt et al., which is hereby incorporated by reference to the same extent though fully replicated herein. In preparing the ink, care is taken to select ingredients from the list of optional ingredients in Moffat et al. so as to avoid use of aldehydes, ketones, and diols, and most aromatic compounds. The ink so prepared may be used in the system 100 for ink jet printing of thermochromic inks.

FIG. 6 shows a label 600 at various stages 602, 604, 606 of printing. At stage 602, background ink 608 is printed, such as a white background. Stage 604 entails printing a thermochromic band 610 over the background ink 608 by screen printing or, alternatively, ink jet printing using the ink described above. A promotional code 612 is printed over the thermochromic band 610 using the same ink used as the background ink 608. The thermochromic band 610 is colorless at normal room temperature and changes color when cooled to a predetermined temperature. This predetermined temperature may be, for example, temperature of 5° C. indicating that a beverage has cooled to an optimum temperature to enhance organoleptic properties of a beverage. The color transition renders the code 612 visible to the naked eye, as the code 612 contrasts with the thermochromic band 610. This color transition of the thermochromic band 610 may be, for example, from clear to blue. The promotional code 612 is optionally topcoated with a clear coating 614 to hide differences in glossiness between the background ink 608 and code 612.

Direct Print over Thermochromic Band with Matching Colors

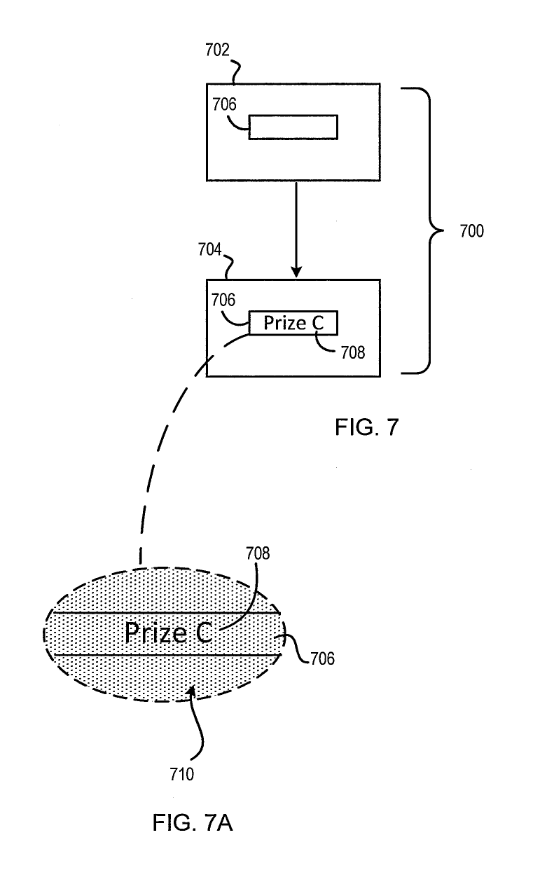

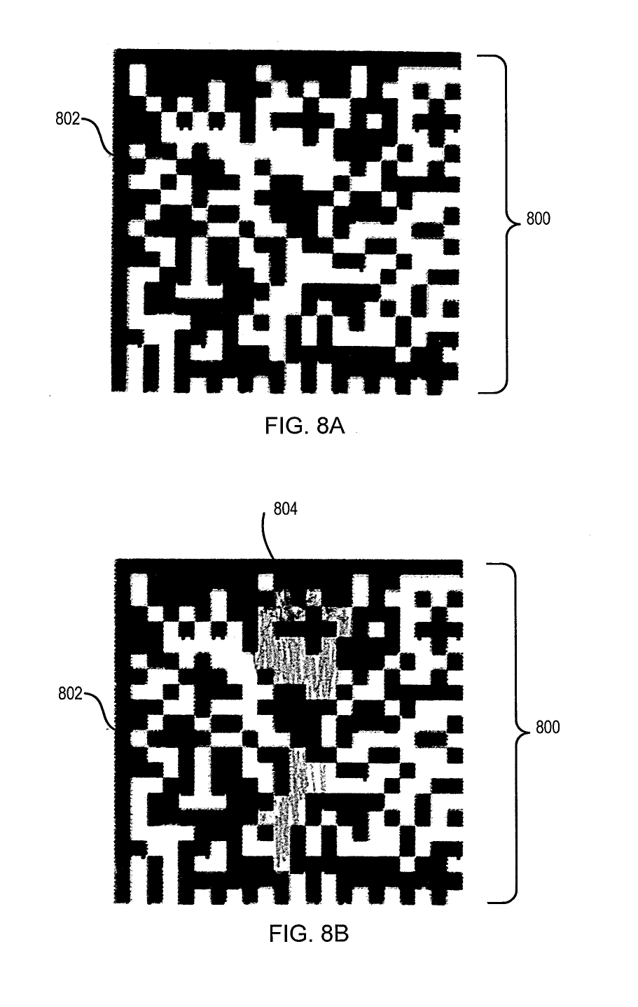

FIG. 7 shows a label 700 at various stages 702, 704 of printing. At stage 702, a thermochromic background ink 706 is printed. At stage 706, a promotional code 708 is printed. The ink used to print the promotional code matches exactly the color of the thermochromic background ink 706 at normal room temperature, such as matching burgundy colors. The thermochromic background ink 706 changes color when chilled to a predetermined temperature, for example, transitioning from burgundy to blue. As shown in the expanded view of FIG. 7A, the promotional code 708 may be cross-hatched with thermochromic ink to hide slight differences between the background ink 708 and the thermochromic ink used to make the promotional code 708.

### Matrix Code

FIG. 8A is a first two dimensional matrix code 800 that may be printed as a label 802 using a first thermochromic ink that is clear at normal room temperature and transitions to a visible color, such as orange, upon being cooled to a first predetermined temperature. The label 802 is printed with a second thermochromic ink having a color transition temperature lower than the first predetermined temperature. The second thermochromic ink has, for example, transitions from clear to a color, such as black, to revel a second matrix code 804. Thus, the label 802 is provided with a first matrix code 800 that may be revealed when a beverage is chilled to a state of being refrigerator code, and another matrix code 804 when the beverage is chilled to being freezer cold. The matrix codes 800, 804 may be scanned using, for example, an iPhone application and transmitted to a central server for processing according to promotional contest rules.

### Hidden Images

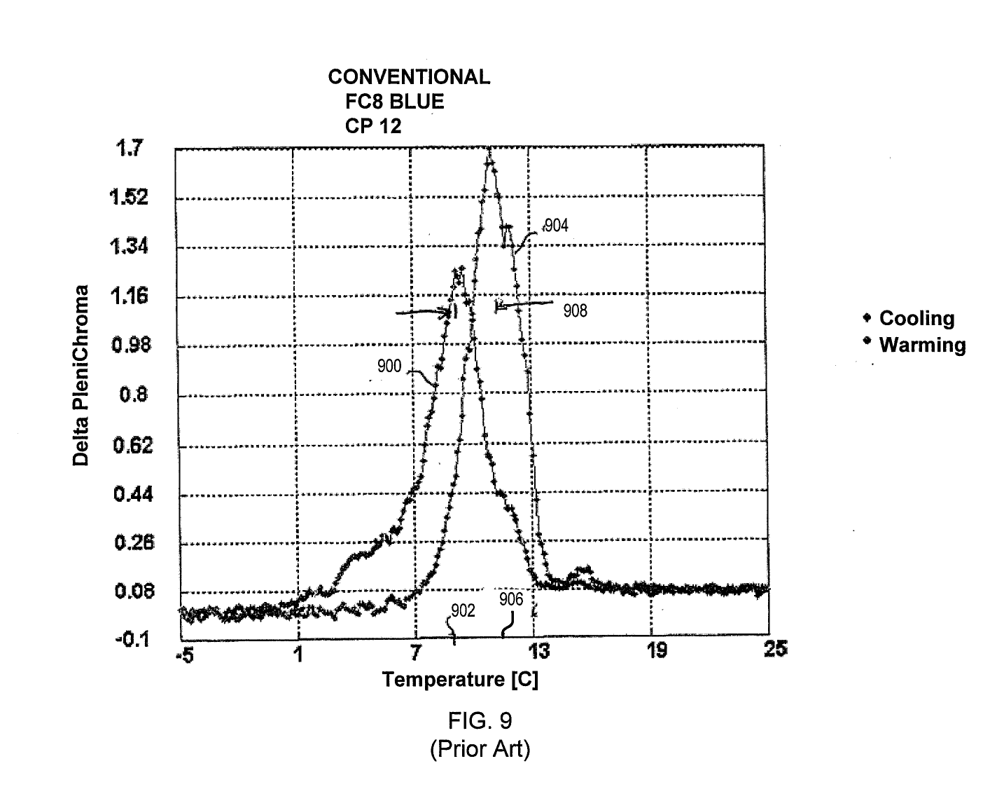

Hidden images, codes or messages may also be printed using a plurality of thermochromic inks, for example, to provide multiple messaging functionality. FIG. 9 shows the rate of color change (delta pleni chroma) in a conventional thermochromic pigment as may be incorporated in a thermochromic ink. A cooling curve 900 shows a point 902 of full color development at about 8° C. Thus, as the pigment cools it develops a full color, such as a blue color, at 8° C. When the pigment warms, as demonstrated by warming curve 904, point 906 represents a clearing point where the pigment loses its color, transitioning to clear. A gap 908 between the full color point 902 and the clearing point 906 is relatively narrow at approximately 4° C.

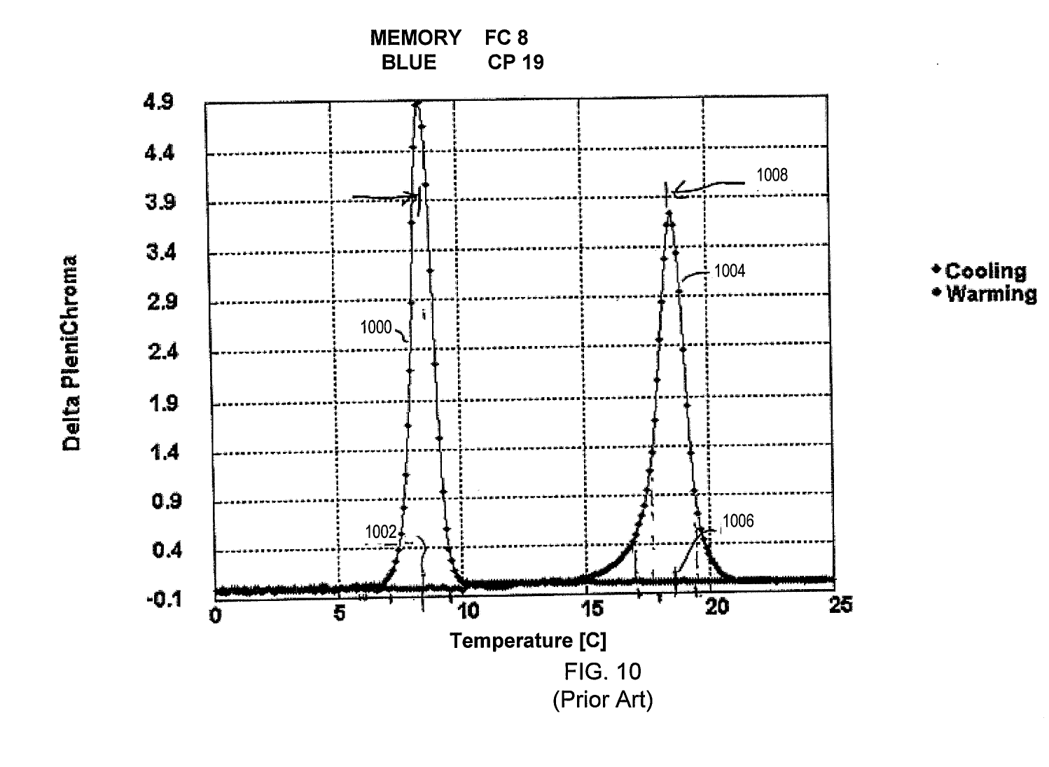

FIG. 10 shows the performance of a second thermochromic pigment having a wider gap between cooling and warming curves. A cooling curve 1000 shows a point 1002 of full color development at about 8° C. Thus, as the pigment cools it develops a full color, such as a blue color, at 8° C. When the pigment warms, as demonstrated by warming curve 1004, point 1006 represents a clearing point where the pigment loses its color, transitioning to clear. A gap 1008 between the full color point 902 and the clearing point 906 is relatively broad at approximately 11° C. The broadness of this separation makes the pigment suitable for use in what the industry refers to as wide hysteresis ‘memory inks.’ As used herein, a “memory ink” is a thermochromic in that has a clearing point and a full color point such that the difference between the clearing point and the full color point is greater than 4° C. This difference is preferably from 6-10° C. and is most preferably greater than 10° C. A “standard thermochromic ink” is one where the difference between the clearing point and the full color point and the clearing point is equal to or less than 4° C.

Thermochromic pigments like those represented in FIGS. 9 and 10 may be purchased on commercial order from such manufacturers as Chromatic Technologies, Inc. of Colorado Springs, Colo. It will be appreciated that the respective pigments represented in FIGS. 9 and 10 may use the same leuco dye and the same developer to achieve the exact shade of color development between the two pigments. The internal phase or solvent carrying the dye and developer may be varied as a matter of design choice to affect the size of gaps 908, 1008, as well as the specific temperatures of full color points 902, 1002, and the clearing points 906, 1006. A comparison of FIGS. 9 and 10 confirms that the full color points 902, 1002 coincide at approximately 8° C., which means that the pigment of FIG. 9 and that of FIG. 10 will achieve full color at approximately the same time and temperature. However, upon warming, the pigment of FIG. 9 transitions to clear at approximately 12° C. while the pigment of FIG. 10 is a ‘memory ink’ that retains its color out to approximately 19° C. This creates a situation where the two pigments may be used alone or in combination to present indicia that displays upon warming in the interval from 12° C. to 19° C.

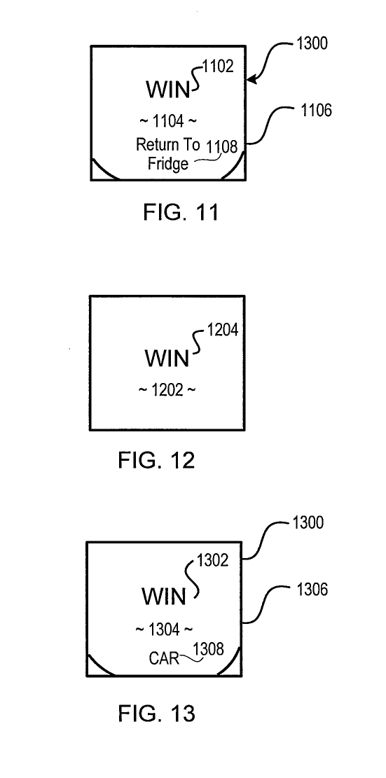

FIG. 11 shows a multiple thermochromic patch 1100 where indicia 1102 is printed using a first ink or coating that contains a first thermochromic pigment having a full color point of 8° C. and a clearing point of 25° C. A background ink 1104 is a standard thermochromic ink that contains a first thermo chromic pigment having a full color point of 8° C. and a clearing point of 12° C. The background ink 1104 may be printed over an optional base coating 1106. Optionally also, a second indicia 1108 may printed over the base coating 1106 and beneath the background ink 1104, which overcoats the base coating 1106 and the second indicia 1108. The second indicia resides under the background ink 1104 and may be printed using a conventional non-thermochromic ink or a photochromic ink. It will be appreciated that the specific temperature points of 8° C., 12° C., and 25° may vary by design.

The patch 1100 may be printed on a beverage can, label or packaging. Upon cooling to 8° C. where full color development is achieved, the patch 1100 appears as a solid color patch having no indicia, except that elements of the base coating 1106 may be visible. The background ink 1104 turns to clear at 12° C. when a beverage or other product is subjected to warming. Upon clearing of the background ink, the indicia 1108 is revealed to announce that the beverage should “RETURN TO FRIDGE.” The first ink constituting indicia 1102 stays blue as warming continues up to 25° C. at which point the first ink also disappears.

FIG. 12 shows another embodiment including patch 1200 where a base ink 1202 utilizes conventional non-color-changing ink or, optionally, a photochromic ink. Indicia 1204 is made using a thermochromic ink, for example, with a full color point of 8° C. and a clearing point of 25° C. The base ink 1202 and the indicia 1204 appear as the same color when the temperature if above 25° C., but as contrasting colors such a blue on white when the indicia 1204 has developed full color.

The patch 1200 may be printed on a beverage can, label or packaging. Cooling to 8° C. achieves full color development such that indicia 1204 appears on the base ink 1202. Upon warming, where the color development is maintained in the range from 8° C. to 25° C. and the upper end of this range if above room temperature (approximately 21° C.) but is less than human body temperature, it is possible to touch the indicia 1204 for sufficient warming to occur such that the indicia 1204 disappears. Thus, also, the indicia 1102 of FIG. 11 may be made to disappear by touching.

FIG. 13 shows a multiple thermochromic patch 1300 where indicia 1302 is printed using a first ink or coating that contains a first thermochromic pigment having a full color point of 8° C. and a clearing point of 12° C. A background ink 1304 contains a first thermo chromic pigment having a full color point of 8° C. and a clearing point of 25° C. The background ink 1304 is printed around the indicia 1302 and may also be printed over an optional base coating 1306. Optionally also, a second indicia 1308 may printed over the background ink 1306 The second indicia contrasts with the developed color of the background ink 1304, resides under the background ink 1304 and may optionally be printed using a photochromic ink.

The patch 1300 may be printed on a beverage can, label or packaging. Upon cooling to 8° C. where full color development is achieved, the patch 1300 appears as a solid color patch having no indicia, except that elements of the base coating 1306 may be visible. The indicia 1302 turns to clear at 12° C. when a beverage or other product is thereafter subjected to warming. Upon clearing of the indicia 1302, the base coating 1306 is revealed to make the indicia 1302 readable to announce that the prize is a car. The background ink 1304 stays blue as warming continues up to 25° C. at which point the background ink also disappears.

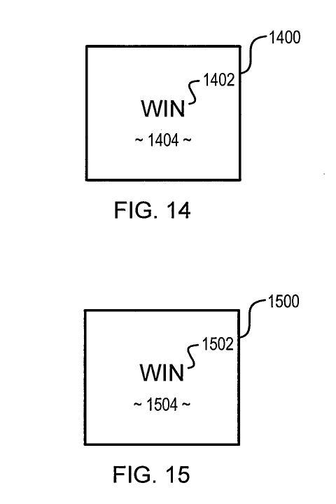

In the embodiment of FIG. 14, patch 1400 contains an indicia 1402 that is printed using a first thermochromic ink that transitions from purple to pink at a full color point of 8° C. The first thermochromic ink has a clearing point of 12° C. A background ink 1404 has a full color point of 8° C. and a clearing point of 25° C. Thus, a purple message “WIN” is revealed against a pink background as warming progresses above 8° C. to 25° C. The message changes blue upon further warming, for example, as may occur by the touch of a hand. The specific colors used, such as purple to pink and purple to blue, may vary by design so long as the first color of the two inks matches. Thin this case the first color is purple, which may vary by design, as may the transition from the first color to blue or pink.

In the embodiment of FIG. 15, patch 1500 contains indicia 1502 which is printed using first ink that contains a photochromic pigment, and may optionally also contain a thermochromic pigment. A background ink or coating 1504 is a conventional ink, such as a blue, yellow or red ink, but may optionally also contain a thermochromic pigment. The first (photochromic) ink is normally clear indoors, but may be color-activated by exposure to sunlight. Thus, on a blue form of background ink 1504, a photochromic activation to produce yellow on indicia 1504 displays the indicia 1504 as a blend of yellow and blue to impart a green hue to indicia 1502. The photochromic material in indicia 1502 may be selected to provide different color transitions. Thus, a photochromic transition to red over a blue background causes indicia 1502 to appear as purple. Similarly, when the background ink 1504 is yellow, photo chromic activation of indicia 1502 to blue causes indicia 1502 to appear green. When the background ink 1504 is yellow, photo chromic activation of indicia 1502 to red causes indicia 1502 to appear orange. When the background ink 1504 is red, photo chromic activation of indicia 1502 to blue causes indicia 1502 to appear purple. When the background ink 1504 is red, photo chromic activation of indicia 1502 to yellow causes indicia 1502 to appear orange.

It will be appreciated that thermochromic inks develop color over a temperature interval and there is no sharp transition as a switch where all color appears at once or disappears at once. The discussion above uses a delta-chroma analysis to define a particular temperature, but acknowledges that the transition of color occurs over a range of temperature, frequently 1-4° C., as an inherent property of thermochromic inks. In the discussion above where two thermochromic inks or pigments are used in combination and share a common full color point, this constitutes an especially preferred embodiment where the standard thermochromic ink and the ‘memory ink to turn on simultaneously. This prevents premature revelation of the hidden message, code or image. For many applications, it will be merely preferred to have the full color point of one pigment be within from 0° C. to 20° C. of the other. A range of from 0° C. to 4° C. is more preferred, and a difference of less than 1° C. is even more preferred.

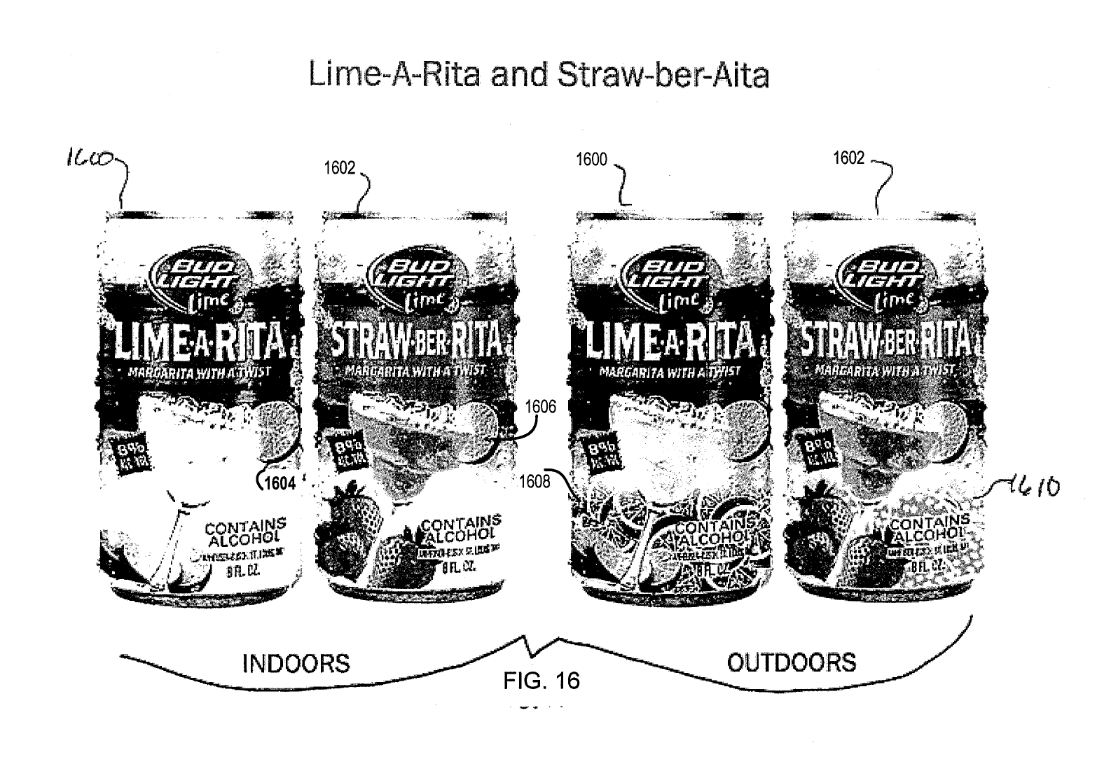

FIG. 16 shows various combinations of the foregoing instrumentalities. Cans 1600, 1602 are respectively printed with thermochromic indicia 1604, 1606 depicting a lime that is normally white but demonstrates thermochromic activity by turning green at temperatures below a target temperature, such as 34° F. When the cans are taken outdoors, direct sunlight activates photochromic dye materials that reveal additional limes 1608, and additional strawberries 1610.

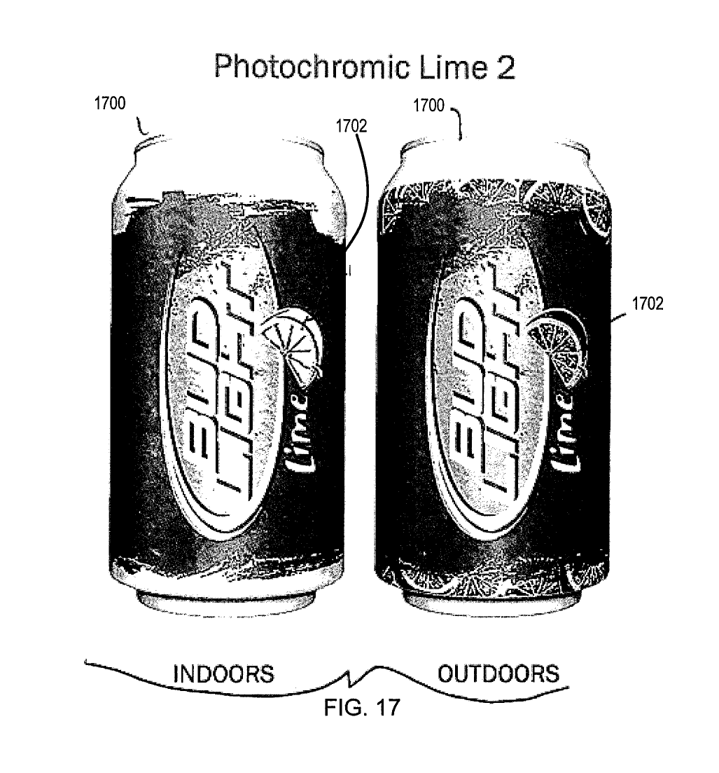

Similarly, FIG. 17 shows can 1700 that has indicia depicting a lime 1702. The lime is a first color, such as white at room temperature indoors. Chilling of the can to a target temperature, such as 34° C., may cause all or part of the lime 1702 to turn green. When taken outdoors into direct sunlight, the lime 1702 changes color and may use a photochromic effect to appear as a deeper green that is divided by yellow segments that appear only in the sun.

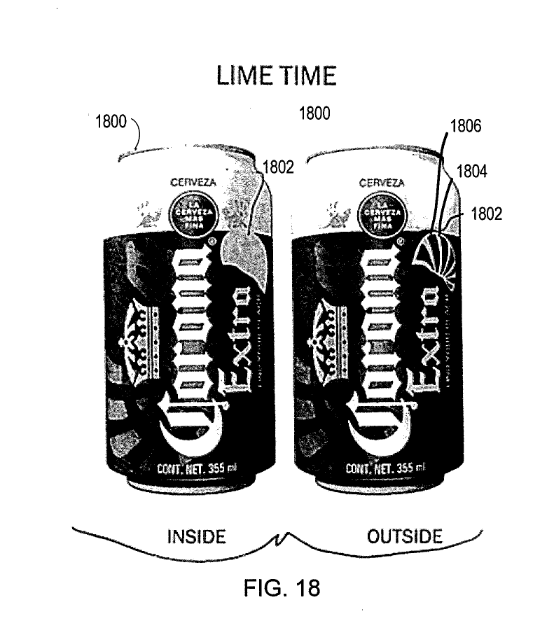

FIG. 18 shows can 1800 that has indicia depicting a lime 1802. The lime is a first color, such as white at room temperature indoors. Chilling of the can to a target temperature, such as 34° C., may cause all or part of the lime 1802 to turn green. When taken outdoors into direct sunlight, the lime 1802 changes color and may use a photochromic effect to appear as a deeper green that is divided by yellow segments that appear only in the sun.

FIG. 18 shows can 1800 that has indicia depicting a lime 1802. The lime is a first color, such as white at room temperature indoors. Chilling of the can to a target temperature, such as 34° C., may cause all or part of the lime 1802 to turn green. When taken outdoors into direct sunlight, the lime 1802 changes color and may use a photochromic effect to appear as a deeper green that is divided by yellow segments that appear only in the sun.

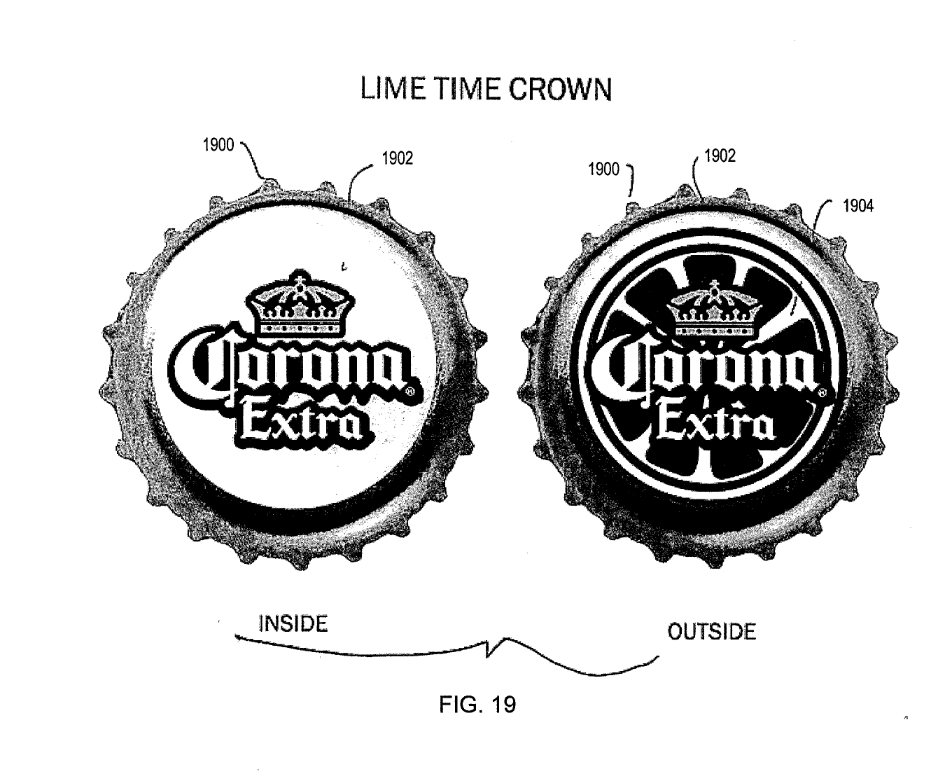

FIG. 19 shows a crown 1900 that has indicia depicting a lime 1902 in different shades of grey. Chilling of the crown to a target temperature, such as 34° C., may cause all or part of the lime 1802 to turn yellow. When taken outdoors into direct sunlight, the lime 1902 changes color and may use a photochromic blue effect to appear green that is divided by yellow thermochromic segments that appear yellow in areas that are not mixed with photochromic dye.

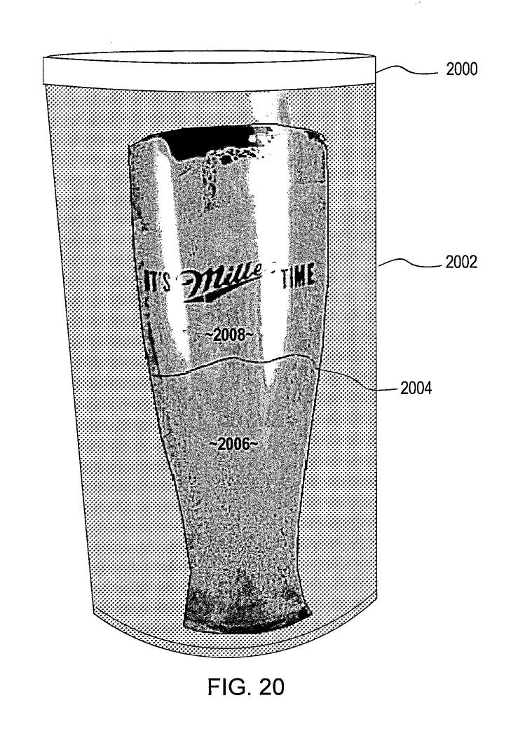

FIG. 20 shows a beverage can 2000 presenting indicia as a pilsner glass 2002 that is printed with thermochromic ink over a white background, or any other background color. Thus, the glass 2002 is normally white, but changes to a yellow color (or any other color change contrasting with the background) by thermochromic action once chilling occurs to a target temperature, such as 40° F. As the internal contents are consumed, the liquid level falls to an approximate level 2004. Beneath level 2004, area 2006 maintains the color yellow remains chilled by the internal contents. Above level 2004, area 2008 is warmed by the air. This causes the yellow to fade to white. This may be combined with photochromic effects, such as changing the logo “ITS MILLER TIME” from red to green in direct sunlight.

The foregoing discussion teaches by way of example and not by limitation. Those skilled in the art understand that what is claimed may be subjected to insubstantial changes without departing from the true scope and spirit of the invention. Accordingly, this inventors hereby state their intention to rely upon the Doctrine of Equivalents in protecting their rights in what is claimed.

1. A label that supports use of variable printing of indicia using thermochromic ink, comprising:
a background ink having a first color;
a thermochromic ink overlaying the background ink; and
means for concealing indicia that is revealed when the thermochromic ink undergoes a color transition.

2. The label of claim 1 where the means for concealing includes:
the indicia printed over the background ink, the indicia being printed with an ink that matches the background ink; and
the thermochromic ink being colorless at room temperature and exhibiting a color change upon sufficient cooling to reveal the indicia.

3. The label of claim 1 where the means for concealing includes:
indicia printed in thermochromic ink over the background ink, the indicia being printed with an ink that is colorless at room temperature and exhibiting a color change upon sufficient cooling to reveal the indicia.

4. The label of claim 1, wherein the means for concealing indicia includes:
a first thermochromic ink that has a first non-clear color when a first thermochromic pigment of the first thermochromic ink is nondeveloped, and a second color when the first thermochromic pigment of the first thermochromic ink is developed,
a second thermochromic ink that has the first color when a second thermochromic pigment of the second thermochromic ink is nondeveloped, and produces a third color distinct from the second color when the second thermochromic pigment of the second thermochromic ink is developed,

5. The label of claim 1, wherein the means for concealing indicia includes a background ink that is overlain by a photochromic ink to create a color change by blending of color between the photochromic ink and the background ink when the photochromic ink is activated by light.

6. The label of claim 5, wherein the background ink has a thermochromic pigment such that different colors appear by blending of color form the photochromic ink when activated by light according to when the pigment of the thermochromic ink is in a state of developed color or undeveloped color.

7. The label of claim 1, wherein the means for concealing indicia includes a thermochromic ink that is mixed with a photochromic pigment.

8. The label of claim 1, wherein the means for concealing indicia includes a standard thermochromic ink used in combination with a memory ink.

9. The label of claim 1, wherein the means for concealing indicia includes an thermochromic ink having pigment with a clearing point that may be achieved by physical contact or manipulation of the human hand.

10. The label of claim 1, wherein the means for concealing indicia includes a memory ink that is used with a non-thermochromic ink.

11. The label of claim 1, wherein the means for concealing indicia includes a standard thermochromic ink used in combination with a non-thermochromic ink.
